(19) United States
(12) Patent Application Publication
(10) Pub. No.: US 2015/0220948 A1
(43) Pub. Date: Aug. 6, 2015

(54) ON-SITE ELECTION METHOD AND APPARATUS

(71) Applicant: NTN Buzztime, Inc., Carlsbad, CA (US)

(72) Inventors: Justin Cooper, Poway, CA (US); Frank Dale Hankin, Carsbad, CA (US)

(73) Assignee: NTN Buzztime, Inc., Carlsbad, CA (US)

(21) Appl. No.: 14/173,624

(22) Filed: Feb. 5, 2014

(51) Int. Cl. G06Q 30/02; H04M 3/487; G07C 13/00

(52) U.S. Cl. CPC G06Q 30/0203; G07C 13/00; G06Q 30/0217; G06Q 30/0235; H04M 3/4878

(57) ABSTRACT

Described are a system, method, and apparatus for providing on-site election services. In one embodiment, a method for providing on-site election services comprises generating an identification of goods or services for election by a plurality of customers, each customer operating a respective wireless communication device, providing the identification of goods or services to the plurality of customers, receiving an election from at least one of the wireless communication devices, the election indicative of at least one of the goods or services in the identification of goods or services, tallying the elections received from the at least one wireless communication device, and sending a result of the election to the wireless communication devices, the result comprising an indication of the tally for at least one of the goods or services in the identification of goods and services.

### BACKGROUND

I. Field of Use

The present application relates to interactive on-site election, or voting, services. More particularly, the present application relates to a service where users vote, select, elect or otherwise choose preferred goods or services.

II. Description of the Related Art

Today's competitive economy forces restaurants, retail stores, and other providers of goods and services to maximize every opportunity to increase sales and encourage customer loyalty. Rewards programs have been used in a variety of industries to promote customer loyalty. Numerous promotions, events and schemes have been developed in an effort to drive or entice customer's spending habits. However, new programs are needed to engage consumers, as previous programs have become commonplace, thereby reducing the differentiating factors between businesses offering previous programs.

Further, in spite of the extraordinary effort that has been expended in developing, supporting, and maintaining prior art customer spending programs, no program has been shown to truly improve consumer loyalty or increase spending habits.

Thus, it would be desirable for merchants and other providers of goods and services to provide a new and improved service or program to increase customer retention and customer spending habits.

### SUMMARY

The embodiments described herein relate to methods and apparatus for providing on-site election services to a plurality of customers in a venue, each of the customers operating a respective wireless communication device in communication with the server.

In one embodiment, a method for providing an on-site election of goods or services comprises generating an identification of goods or services for election by a plurality of customers, each customer operating a respective wireless communication device, providing the identification of goods or services to the plurality of customers, receiving an election from at least one of the wireless communication devices, the election indicative of at least one of the goods or services in the identification of goods or services, tallying the elections received from the at least one wireless communication device, and sending a result of the election to the wireless communication devices, the result comprising an indication of the tally for at least one of the goods or services in the identification of goods and services.

In another embodiment, a wireless communication device is described for allowing a user of the wireless communication device to provide elections of preferred goods or services to a server, comprising a communication interface for wirelessly transmitting and receiving information with the server, a user interface for receiving user input and for displaying information to the user, a memory device for storing processor-executable instructions, and a processor coupled to the communication interface, the user interface, and the memory for executing the processor-executable instructions that cause the wireless communication device to receive an identification of goods or services from the server, display the identification of goods or services to the user, receive an indication from the user, via the user interface, of at least one preferred good or service in the identification of goods or services, transmit the indication to the server, receive a result of an election of the goods or services in the identification of goods or services, the result comprising an indication of goods or services in the identification of goods or services that are most preferred by a plurality of users, each of the plurality of users operating a respective wireless communication device.

In yet another embodiment, a server for providing an on-site election of goods or services to a plurality of customers in a venue is described, each of the customers operating a respective wireless communication device in communication with the server, the server comprising, a communication interface for transmitting and receiving information with the wireless communication devices, a memory device for storing processor-executable instructions, and a processor coupled to the communication interface and the memory for executing the processor-executable instructions that causes the server to provide a sub-section of good or services normally offered to the customers via their respective wireless communication devices and a notification that the customers may vote for one or more preferred goods or services in the sub-section, receive elections from one or more of the wireless communication devices, each of the elections representing one or more preferred goods or services of the sub-section of goods or services from a respective customer, tally the elections received from the wireless communication devices, and send a result of the election to the wireless communication devices, the result comprising an indication of relative popularity of the goods or services in the sub-section of goods or services as determined by the number of elections received from the wireless communication devices.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of a system for providing an interactive program to consumers located on a merchant's premises where the consumer votes, selects or otherwise chooses a preference;

FIG. 2 is a functional block diagram of one embodiment of one of the servers shown in FIG. 1 in an embodiment where one or both servers provide the interactive program illustrated in FIG. 1;

FIG. 3 is a functional block diagram of one embodiment of one of the personal communication devices shown in FIG. 1; and

FIG. 4 is a flow diagram illustrating one embodiment for providing an interactive program to consumers located on a merchant's premises where the consumer votes, selects or otherwise chooses a preference.

### DETAILED DESCRIPTION

The present disclosure relates to a variety of embodiments related to apparatus and methods of providing interactive election services to consumers located on a merchant's premises where the consumer votes, selects, elects, or otherwise chooses one or more favorite or preferred goods and services offered by the merchant. Election services may be described as allowing customers of a venue to elect, or vote, on their favorite food or beverage items, for example, for the purpose of proving the most popular goods and services to the customers for their enjoyment in hopes that the customers spend more money while at the venue, as well as to increase customer loyalty and retention. Based on a tally of elections from customers, a merchant can offer goods and services to customers in a way that takes into consideration the results of each election, for example, by providing incentives for customers to purchase items found to be most popular. The interactive election services provide a way for customers to be part of a selection process for the types and cost of goods and services offered to a group of customers as a whole, thereby creating an atmosphere of fun and entertainment at the merchant's premises.

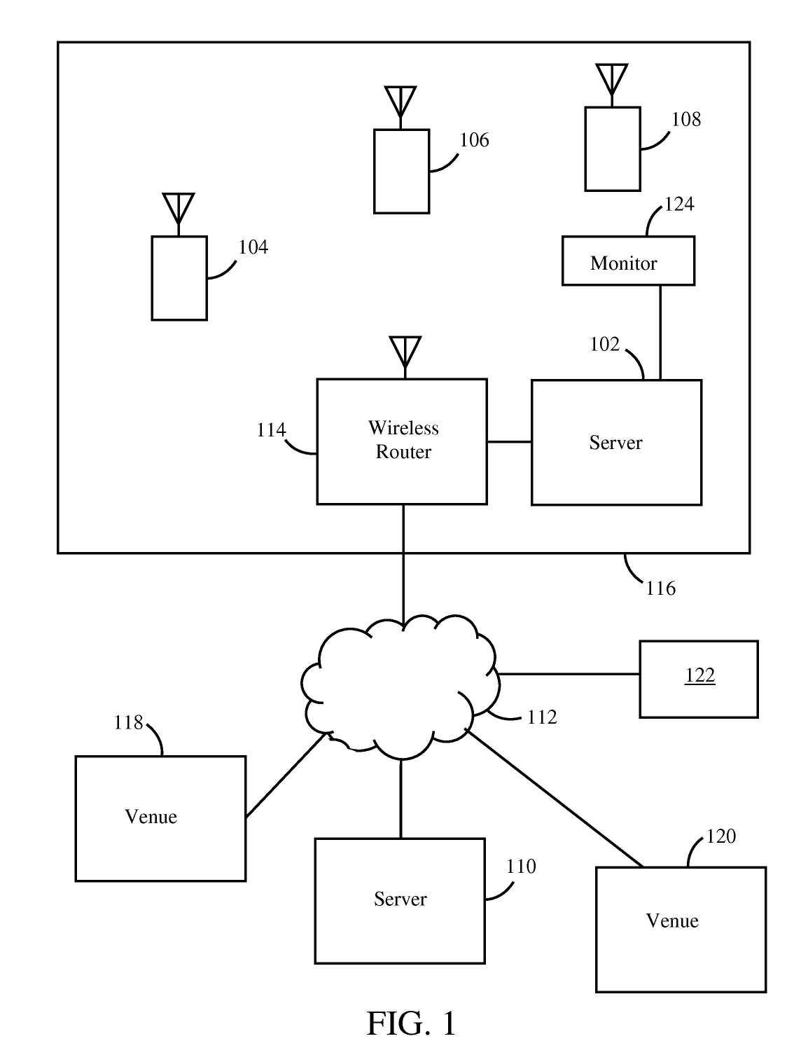

FIG. 1 illustrates one embodiment of a system 100 for providing interactive election services to consumers located on a merchant's premises where the consumer votes, selects, elects or otherwise chooses one or more favorite or preferred goods and services offered by the merchant. In the embodiment shown if FIG. 1, system 100 comprises server 102 located within venue 116, and three wireless communication devices 104, 106, and 108 also located within venue 116. System 100 may optionally include remote server 110 in communication with server 102 via wide area network 112 and wireless router 114. In another embodiment, election services are provided by remote server 110 to the wireless communication devices without the use of server 102, such as in an embodiment where the election services are provided to venue 116 remotely over wide area network 112. Wide area network 112 comprises any public or private communication network, or a combination of such networks, such as the Internet, cellular data networks, cellular voice networks, satellite communication networks, and/or fiber optic communication networks, etc. Although only three wireless communication devices are shown in FIG. 1, in practical applications, a plurality of wireless communication devices is typically found within venue 116 and provided with election services from server 102, server 104, or a combination of both. For example, server 110 may communicate with server 102 to provide server 102 with executable code used to provide election services to the wireless communication devices.

System 100 may additionally comprise one or more public viewing monitors 124. Such public viewing monitors are commonplace in venues such as bars and sporting events for providing visual information such as images, videos, advertisements, television shows, sporting events, etc. to a number of patrons or customers within a venue. Each public viewing monitor 124 typically comprises a video display, such as an LCD or LED display, which may include a tuner for allowing viewers to watch a particular channel out of a number of channels provided by server 102/110 or some other source such as a satellite or cable television receiver. The public viewing monitors also typically comprise an audio output device, such as speakers, for allowing patrons and customers to hear audio information associated with the visual information displayed by the monitors.

Each of the wireless communication devices 104, 106, and 108 comprise a portable electronic computing device capable of wireless communication with server 102/110, such as a Smartphone, tablet computer, laptop computer, or any other device capable of wireless communications with a cellular data network or a local data network such as a Wi-Fi LAN provided by wireless router 114. For example, wireless communication device 104 may comprise one of a variety of Wi-Fi enabled tablet computers sold by a variety of computer manufacturers, such as the iPad tablet computer manufactured by Apple Computer of Cupertino, Calif., or the Galaxy Tab tablet computer manufactured by Samsung Electronics of Seoul, Korea. In other embodiments, one or more of the wireless communication devices may comprise a Smartphone, such as an iPhone manufactured by Apple Computer. In one embodiment, any one of wireless communication devices 104, 106, and 108 comprise a tablet computer specially provisioned by venue 116. For example, a restaurant chain may provision a plurality of customized tablet computers for use in their venues, the tablet computer comprising the restaurant chain's logo as wallpaper, and pre-loaded with a number of “apps” for providing services to customers including an ability to goods and services available for purchase, and to elect their favorite goods and services when prompted by server 102/110 as will be described below. The apps typically work in conjunction with server 102 and/or server 110 by transmitting and receiving messages related to the election services. The customized tablets may be provided to customers as they arrive on the provider's premises. For example, a restaurant/bar may provide a customized tablet to each customer seated at tables located throughout the restaurant/bar. In any case, each wireless communication device typically comprises a display for presenting visual information to customers, a user input device, such as a keypad, microphone, touchpad, or other known input device, to receive information from customers, and a communication interface that allows signals to be transmitted and received to/from the wireless communication devices.

In one embodiment, a networked computer operator using networked computer 122 could also participate in election services in addition to operators of the wireless communication devices in venues 116, 118, and 120. Additionally, off-site wireless communication devices could participate in election services offered by a venue. For example, a Smartphone could be used to receive alerts from venue 116 when an election is about to begin. In response to receiving the alert, an operator of the Smartphone could participate in the election by registering with server 102 and/or server 110, and participate in an election process as if the operator was located within venue 116.

The same election services provided by server 102 and/or server 110 may also be provided to one or more other venues, such as venue 118 and venue 120 as shown in FIG. 1. Each venue 116, 118, and 120 is a public venue such as a bar, restaurant, nightclub, sporting event venue, casino, hotel, retail store, movie theater, Laundromat, or any other public venue where election services may be provided to customers or patrons of such public venues. A number of wireless communication devices similar to WCDs 104, 106, and 108 may be located within these other venues and participate in election services in concert with wireless communication devices located within their respective venues, or with or against wireless communication devices located at other venues.

Election services may be offered to customers in one of several embodiments. In one embodiment, server 102/110 provides customers with a sub-set, or sub-selection, of goods and services regularly offered to customers. For example, a restaurant may offer a standard menu of food and beverages to their customers electronically via each customer's wireless communication device, i.e., a digital menu provided by server 102/110. The sub-set, or sub-selection, of goods and services may comprise, for example, a selection of three appetizers from ten appetizers normally offered to customers on the digital menu. The sub-set, or sub-selection, may be offered to customer so the customers may vote on their favorite appetizer and provides their votes wirelessly to sever 102/110. Customers are typically given a time period in which to cast their votes, or elections. As elections are received from the wireless communication devices, server 102/110 tallies, or simply stores, the elections to determine a relative ranking of the popularity of each of the items in the sub-selection. As elections are received by server 102/110, server 102/110 may provide feedback information to the customers pertaining to the tally. For example, in an embodiment where server 102/110 provides a sub-set of five types of beverages, inviting customers to cast a vote for their favorite beverage, half-way through the voting process, server 102/110 could provide an update to the customers of how many elections each item has received. At the end of the election time period, server 102/110 informs the customers of the final result of the election, and then performs one or more possible actions based on the election results, as will be described in greater detail below.

In another embodiment, election services can be used in conjunction with a music service, such as an in-venue jukebox, or music playback system, that provides a list of song titles that are selectable by the customers using their wireless communication devices for playback over a jukebox or music system located within the venue where the customers are located. Server 102/110 may provide such a song list to customers via their wireless communication devices and/or public viewing monitor(s) 124. Additionally, a queue of the next songs to be played in sequence may be provided to customers via their wireless communication devices and/or public viewing monitor(s) 124. Server 102/110 may receive elections or votes for a song title, and then perform one of a number of possible actions based on the number of votes for each song title, artist, album, genre, or other song attribute received.

In yet another embodiment, election services may comprise offering games to customers based on a number votes or elections each game receives from customers. In this embodiment, server 102/110 may provide a number of multi-player games to customers, such as trivia games, poker, bingo, sports-related games, or other games where two or more customers play a game with or against each other. A list of games may be provided to customers by server 102/110 and the customers can vote on the game that they would most like to be played next. In another embodiment, a game type may be voted on. For example, server 102/110 provides a notification to customers of an upcoming trivia game, and allows customers to vote to determine if the trivia game will be based on current events, sports, TV shows, or some other genre. Further details of this embodiment are provided below.

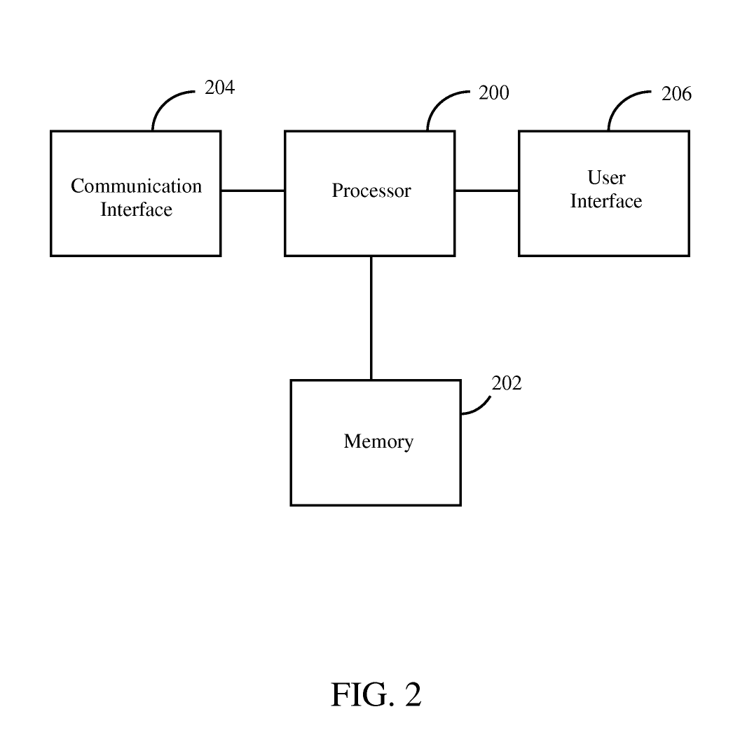

FIG. 2 is a functional block diagram of one embodiment of server 102 or server 110. Specifically, FIG. 2 shows processor 200, memory 202, communication interface 204, and user interface 206. It should be understood that not all of the functional blocks shown in FIG. 2 are required for operation of server 102/110 (for example, user interface may not be necessary), that the functional blocks may be connected to one another in a variety of ways, and that not all functional blocks necessary for operation of server 102/110 are shown (such as a power supply), for purposes of clarity.

Server 102 may comprise virtually any commercially-available servers on the market today, including the P4300IP server system manufactured by Intel Corporation of Santa Clara, Calif. Processor 200 provides general operation of server 102 by executing processor-executable instructions stored in memory 202, for example, executable code. Processor 200 typically comprises a general purpose processor, such as any of the Xenon® family of processors manufactured by Intel Corporation of Santa Clara, Calif., although any one of a variety of microprocessors, microcomputers, and/or microcontrollers suitable for a server-type application may be used alternatively.

Memory 202 comprises one or more information storage devices, such as hard drives, RAM memories, ROM memories, flash memories, and/or virtually any other type of electronic, optical, or mechanical memory device, but excludes propagated signals. Typically, memory 202 comprises more than one type of memory. For example, memory 202 may comprise a ROM memory used to store processor-executable instructions for operation of server 102/110, plus one or more hard drives for storing processor-executable instructions relating to election services and other services, such as executable instructions for conducting game play, for displaying and ordering food or beverages, for displaying available music for playback on a venue jukebox system, etc. Memory 202 may also store code for transmission and execution to the wireless communication devices, commonly known as “apps”, for providing the election services. One or more apps may be downloaded from server 102 by wireless communication devices in order for the wireless communication devices to present goods and services to customers and to provide election services in relation to the goods and services.

Communication interface 204 is electronically coupled to processor 200 and comprises electronic circuitry necessary for server 102/110 to communicate with the wireless communication devices via wireless router 114. In the case of server 110, communication interface 104 comprises circuitry for communicating over wide-area network 112. In another embodiment, communication interface comprises wireless communication circuitry to allow server 102 to communicate directly with wireless communication devices within venue 116 via a LAN. Communication interface 204 comprises circuitry, hardware, software and/or firmware necessary to transmit and receive information sent to or from router 114 via one or more commonly-used network protocols, such as the well-known TCP/IP suite of protocols. Alternatively, or in addition, communication interface could comprise electronics and supporting software/firmware to support other well-known communication types, including Wi-Fi, Bluetooth, wireless telephone communications, fiber-optic communications, and so on.

User interface 206 is coupled to processor 200 and is used to allow an individual to control operation of server 102/110 and/or to receive information from server 102. User interface 206 may comprise one or more touchscreens, pushbuttons, switches, sensors, keypads, and/or microphones that generate electronic signals for use by processor 200 upon initiation by a user. User interface 206 may additionally comprise one or more seven-segment displays, a cathode ray tube (CRT), a liquid crystal display (LCD), one or more light emitting diode displays (LEDD), one or more light emitting diodes (LEDs), light arrays, or any other type of visual display. Further, the electronic display could alternatively or in addition comprise an audio device, such as a speaker, for audible presentation of information to a user. Of course, the aforementioned items could be used alone or in combination with each other and other devices may be alternatively, or additionally, used.

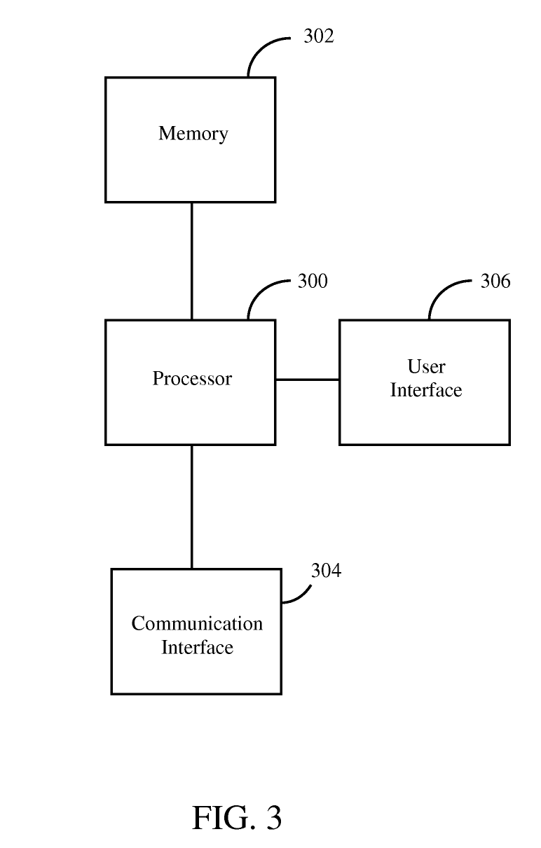

FIG. 3 is a functional block diagram of one embodiment of a typical wireless communication device, such as one of the wireless communication devices shown in FIG. 1. Specifically, FIG. 3 shows processor 300, memory 302, communication interface 304, and user interface 306. It should be understood that the functional blocks may be connected to one another in a variety of ways and that not all functional blocks necessary for operation of a wireless communication device are shown (such as a power supply), for purposes of clarity.

Each wireless communication device may comprise virtually any commercially-available portable or fixed computing device on the market today having communications capabilities, such as any Smartphone, tablet computer, laptop computer, or even a fixed, “desktop” computer. Processor 300 provides general operation of the wireless communication device by executing processor-executable instructions stored in memory 302, for example, executable code. Processor 300 typically comprises a general purpose processor, such as Tegra 2 processor manufactured by Nvidia Corporation of Santa Clara, Calif., although any one of a variety of microprocessors, microcomputers, and/or microcontrollers suitable for allowing mobile computing/communications may be used alternatively.

Memory 302 comprises one or more information storage devices, such as hard drives, RAM memories, ROM memories, flash memories, and/or virtually any other type of electronic, optical, or mechanical memory device, but excludes propagated signals. Typically, memory 302 comprises more than one type of memory. For example, memory 302 may comprise a ROM memory used to store processor-executable instructions for operation of the wireless communication device, plus RAM memory to store one or more apps that provide election services to a wireless communication device operator.

Communication interface 304 is electronically coupled to processor 300 and comprises electronic circuitry necessary for wireless communications with server 102 or 110 via wireless router 114 or via a cellular network. Typically, communication interface comprises circuitry, hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support a variety of well-known communication types, including Ethernet, Wi-Fi, Bluetooth, fiber-optic communications, cellular (such as LTE or WiMax), and so on.

User interface 306 is coupled to processor 300 and is used to allow an operator of the wireless communication device to engage in election or other services offered by server 102/110. User interface 306 may comprise one or more touchscreens, pushbuttons, switches, sensors, keypads, and/or microphones that generate electronic signals for use by processor 300 upon initiation by customers. User interface 306 may additionally comprise one or more liquid crystal displays (LCDs), one or more light emitting diode displays (LEDDs), one or more light emitting diodes (LEDs), light arrays, or any other type of visual display. Further, user interface 306 could, alternatively or in addition, comprise an audio device, such as a speaker, for audible presentation of information to an operator. Of course, the aforementioned items could be used alone or in combination with each other and other devices may be alternatively, or additionally, used. Typically, input device 306 comprises a widely-known touchscreen device capable of displaying information and receiving operator input.

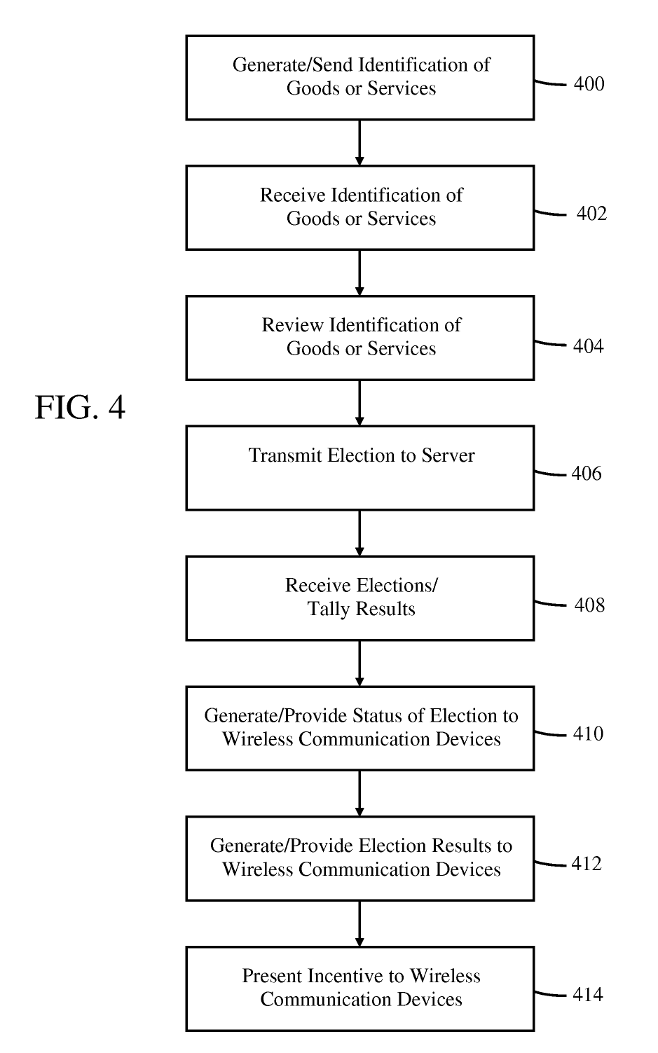

FIG. 4 is a flow diagram illustrating one embodiment of a method for providing election services to customers. The method is performed by a combination of a wireless communication device, such as wireless communication device 104 in FIG. 1, and server 102, server 110, or both. Processor 300 in the wireless communication device executes processor-executable instructions stored in memory 302 that causes the wireless communication device to perform the method pertaining to the wireless communication device, while processor 200 in either server 102, server 110, or both, executes processor-executable instructions stored in a memory 202 associated with the server(s) that causes the server(s) to perform the method pertaining to the server(s). Although the method of FIG. 4 is described in particular as certain operations of the method occurring at server 102/110 or at the wireless communication device, it should be understood that the concepts described could be applied to other embodiments, such as an embodiment where an “app” runs on a wireless communication device and provides a majority of the election functionality to an operator of such a device, without departing from the general inventive concepts described herein.

It should be further understood that in some embodiments, not all of the steps shown in FIG. 4 are performed, and that the order in which the steps are carried out may be different in other embodiments. Further, it should be understood that some minor method steps may have been omitted for purposes of simplifying the method description unnecessary for one skilled in the art to make and use the inventive concepts described. Finally, while the steps are reference only to server 102 in the following discussion, it should be understood that it is intended that the steps be applicable to server 110 in the alternative, or shared between server 102 and server 110.

At block 400, server 102 generates and sends an identification of goods or services to customers located on the premises of a merchant, such as a restaurant, bar, sports venue, movie theater, Laundromat, or other provider of goods or services. In one embodiment, the identification of goods or services comprises a sub-set, or sub selection, of goods or services normally offered to the merchant's customers. The identification of goods or services is provided to customers so that the customers may vote, or elect, their favorite or most-preferred good or service. In one embodiment, the identification of goods or services comprises food and/or beverage items offered at a bar or restaurant. and is provided to customers for purposes of offering customers a limited-time “special” or incentive to purchase one of the foods and/or beverages in the identification of goods or services. For example, the identification of goods or services provided to customers by server 102 may comprise three appetizers, for example chicken wings, potato skins, and nachos. The “special” may be time constrained, i.e., valid for a predetermined time period such as 10 minutes, or “volume” constrained, i.e., valid until a predetermined number of orders have been received, such as 10 orders. The identification of food and/or beverage items generated and provided to customers at this point is typically a sub-set of food and/or beverage items available for ordering by customers at any time from a full menu of food and beverages.

In another embodiment, the identification of goods or services comprises an identification of music in the form of song titles, artist names, album names, and/or music genres that is generated and transmitted to customers. The identification of songs, artists, albums, or music genres is typically a sub-set of a number of songs, artists, albums, or music genres that are offered to customers for playback over a restaurant's sound system, or jukebox, at any time. The identification of songs, artists, albums, or music genres may be offered to customers as a promotion by venue 116 to generate interest and additional sales of musical selections from customers.

In yet another embodiment, the identification of goods or services comprises an identification of a number of multi-player games that is generated and provided to customers. The identification of multi-player games may be generated by venue 116 to allow customers to choose a particular multi-player game, in hopes of providing a game that most customers enjoy and will participate in. The identification of multi-player games may comprise one or more trivia games, sports-related games, bingo, poker, and/or any other game where participants compete against or with each other.

In one embodiment, server 102 transmits a predetermined response time to the customers, representing a time period during which elections by the customers must be received by server 102 in order to be tallied by server 102.

In one embodiment, server 102 transmits a discounted price associated with each item in the identification of goods or services relative to what each item normally retails.

At block 402, the identification of goods or services generated at block 400 is received by one or more wireless communication devices and/or public viewing monitor(s) 124 located in venue 116. The customers may be physically located in the restaurant, or nearby, for example on a deck, patio, passing by on the sidewalk or street outside the restaurant, or in other offices, suites or rooms in the building where the restaurant is located, or otherwise in range of wireless router 114. The customers may also include customers located in different venues, such as venue 118 and 120. Venues 116, 118, and 120 may be related to each other, such as franchises of a chain of restaurants, bars, shops, movie theaters, etc., or the venues may be related to each other in the type of goods and services offered to their customers, such as in an example where venue 116 is a bar owned by one entity, while venues 118 and 120 are bars owned by another entity.

At block 404, the customers who receive the identification of goods or services from server 102 review goods or services using their respective wireless communication devices and/or public viewing monitor(s) 124 and select, vote, elect, or otherwise choose one or more preferred goods or services. In one embodiment, the selection by each customer represents a food or beverage that the customer would like placed on “special”. In another embodiment, the selection by each customer represents a “like” or “dislike” of a current song playing over a sound system, or jukebox, within a venue. In yet another embodiment, the selection by each customer represents a “like” or “dislike” of one or more songs in a queue of songs ready to be played in order after a current song has finished playing on a venue's jukebox or sound system. In yet still another embodiment, the selection represents a preference to play a particular multi-player game out of the selection of games provided in the identification of goods or services that were received at block 402.

In another embodiment, customers may rank the items in the identification of goods or services. For example, the ranking may be from most-liked to least-liked or it may start with most-disliked and proceed to most-liked.

In yet another embodiment, customers are free to enter a good or service not in the identification of goods or services. For example, if the identification of goods or services comprises a shot of whiskey, a shot of vodka, and a shot of tequila, a customer may be allowed to elect some other drink item, such as a shot of rum.

At block 406, at least some of the customers, via their wireless communication devices, transmit their election(s) to server 102. In one embodiment, customers are charged a fee, such as twenty five cents, or a dollar, to submit an election to server 102. The fee may be used to prevent indiscriminant or numerous voting by one or more customers and to ensure fairness among customers.

At block 408, server 102 receives the elections from the customers and tallies the number of votes each item received from the customers. The act of “tallying” may comprise incrementing a counter related to each good or service receiving a vote, or election, from the customers via their wireless communication devices, and storing a count related to each good or service in memory 302.

At block 410, server 102 generates and provides a status of the election to the wireless communication devices and/or public viewing monitor(s) 124. For example, server 102 may generate a new identification of goods or services comprising the same goods or services provided to customers at block 400, but ordered based on at least a ranking, or popularity, of the goods or services as determined by the number of elections received so far by server 102. For example, the first item in the new identification of goods or services is the item that received the most elections, the second item in the new identification of goods or services is the item that received the second most elections, and so on. In another embodiment, the new identification of goods or services comprises a ranking based on at least items receiving the least elections, i.e., the most unfavored items. In yet another embodiment, only the item receiving the most votes (or the item receiving the least votes) is provided as a status or, in another embodiment, one or more indications of item ranking is provided based on the received elections, such as a “star” icon displayed in association with the item that has received the most elections, or numbering or lettering associated with each of the goods or services based on the received elections.

In another embodiment, the status provided by server 102 simply comprises an indication of the number of elections received for each item from the customers. Thus, each item in the original identification of goods or services displayed to customers via their wireless communication devices and/or public viewing monitor(s) 124 along with the number of elections received for each good or service by server 102.

Server 102 may provide the status of the election at regular time intervals, such as once per minute, as each election is received, as a predetermined number of elections are received, and/or at the end of a predetermined time period, such as 10 minutes.

At block 412, server 102 provides a result of the election to the wireless communication devices and/or public viewing monitor(s) 124, either at the conclusion of the predetermined response period provided to customers at block 400, as a result of a certain number of total elections received, a predetermined number of elections received for any of the items in the indication of goods or services, at the conclusion of some event, such as the conclusion of another special or the conclusion of a song played on a sound system, or jukebox, or some other metric, or a combination of the above.

In an embodiment where a selected number of food and/or beverage items were provided to customers at block 400, server 102 may provide an indication of the item that received the most elections, or a final ranking of the items in the indication of goods or services provided to customers at block 400.

In another embodiment, where a number of music selections were provided to customers at block 400, server 102 may provide an indication of the song title, artist name, album name, and/or genre that received the most elections, or a final ranking of the music selections in the indication of goods or services provided to customers at block 400.

In an embodiment where a number of game selections were provided to customers at block 400, server 102 may provide an indication of the game title that received the most elections, or a final ranking of the game titles in the indication of goods or services provided to customers at block 400.

At block 414, server 102 presents an incentive, or an offer, to the customers related to the election results.

In one embodiment, in the case of food and/or beverage items, the item that received the most elections is offered to customers at a price that is discounted from the regular retail price of the item. Server 102 may additionally provide an indication that the discounted price is only available for a limited time period, for example 10 minutes, until a selected time, for example, “until 7 pm”, or until a certain number of items have been purchased. A count-down clock may be displayed by the wireless communication devices and/or public viewing monitor(s) 124, showing the remaining duration of the discounted price offer. Server 102 may provide an indication of the number of items ordered to customers as orders are received by server 102, so that customers may know when the discount or incentive is nearing termination in an embodiment where the discount or incentive is available until a certain number of items have been ordered.

In an embodiment where a number of musical selections were provided to customers at block 400, server 102 causes the sound system, or jukebox, in one or more venues to play the musical selection that received the most elections. In another embodiment, server 102 offers the musical selection that received the most elections to customers at a price that is discounted from the regular retail price of the musical selection. In yet another embodiment, server 102 excludes one or more musical selections that did not receive a predetermined minimum number of elections from either being offered in a future identification of goods or services or from being including in a selection of musical selections available to customers at any time. In another embodiment, the musical selection that received the fewest elections is eliminated from a queue of song titles that are presented to customers via their wireless communication devices or public viewing monitor(s) 124. In yet still another embodiment, a musical selection playing on the sound system, or jukebox, may be halted, and another musical selection, for example a musical selection that received the most votes, may be played instead.

In an embodiment where a number of game titles were provide to customers at block 400, server 102 begins the game title that received the most elections, either at the conclusion of the predetermined response time or some predetermined time thereafter. In another embodiment, as a result of the election, server 102 alters an offering of game titles to customers in accordance with the game titles that received the most elections. For example, as a result of the election, only the top three game titles are offered to customers for future game play.

Variations of the above method are envisioned. For instance, in another embodiment, customers provide feedback, survey results and other information to a restaurant owner through voting queries provided by server 102. For example, server 102 broadcasts a list that comprises a list of all the beers that are available to the customers where the list may also include beers that the restaurant is considering making or purchasing. The action taken would be similar as described above, where the customers may first vote on one or more beers that they like the most and a new list ranking the beers based on the number of received votes is generated in by server 102. Then, server 102 broadcasts either a revised beer list based on the number of votes each beer received, for example, a listing of the beers from most popular to least popular or only an indication of the single beer that received the most votes to the customers. If the beer is currently offered by the restaurant, a discount may be offered, or a date when the beer will be available for sale may be broadcast.

Similar to the above embodiment, a list of food menu items that a restaurant is considering adding to the menu may be broadcast to the customers and voted upon. An incentive to encourage responses may be offered to customers, such as a discounted meal food or beverage item, or a buy-one-get-one-free discount. Another embodiment may comprise a venue using voting queries to alter an environmental aspect of the venue, such as lighting or temperature. In this embodiment, server 102 broadcasts an identification of the lights in the venue, or an indication of various areas of the restaurant that are illuminated, or a temperature of one or more areas in the restaurant. The customers then vote on whether they want the illumination or temperature to increase or decrease for one or more areas of the restaurant. The votes are received by server 102 and tallied. Server 102 may provide updated information as to the tallied votes to the customers. At the conclusion of the voting time period, server 102 broadcasts the results of the vote to the customers. In accordance with the vote, server 102 may cause an illumination system to increase or decrease lighting in one or more areas of the restaurant, or cause an HVAC system to increase or decrease a temperature of one or more areas of the restaurant.

Another embodiment comprises using customer voting to provide benchmarking against other restaurants in the area. For example, server 102 broadcasts a list that comprises a list of all the restaurants in the local area. The customers then vote on their favorite restaurant. Once the favorite restaurant is determined from the voting results, other lists may be generated specific to the restaurant that was voted most favorite. For example, if the restaurant that was voted most favorite had an extensive beer selection, a list of the beer selection may be broadcast and a new list showing the voting results is generated. Then, server 102 provides a message to customers that the beer that generated the most votes will be available soon.

Another embodiment is designed to increase customer loyalty. Votes received by server 102 from each wireless communication device are recorded and the customer who has voted the most during the last week, or month may be elected the “mayor.” The “mayor” is then eligible for half-off beverage prices, or a free lunch or dinner, or a gift card. This embodiment will encourage more customer voting and thus more customer loyalty. One feature of the present invention is that the voting lists described above may be changed in any number of different ways, thereby providing new experiences to the customer, and increasing sales and customer loyalty.

The methods described in connection with the embodiments disclosed herein may be embodied directly in hardware or embodied in processor-executable instructions stored in one or more memories and executed by one or more processors. The processor-executable instructions may reside in RAM memory, flash memory, ROM memory, EPROM memory, EEPROM memory, registers, hard disks, removable disks, CD-ROMs, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, such as the wireless communication device or in server 102 or server 110. In the alternative, the processor and the storage medium may reside as discrete components.

Accordingly, an embodiment of the invention may comprise a computer-readable media embodying code or processor-executable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated. Finally, it should be understood that in the functionality or methods may be distributed between various components, such as among server 102, server 108, and/or the wireless communication devices.

We claim:

1. A method for providing an on-site election of goods or services by a computer server, comprising:
generating an identification of goods or services for election by a plurality of customers, each customer operating a respective wireless communication device;
providing the identification of goods or services to the plurality of customers;
receiving an election from at least one of the wireless communication devices, the election indicative of at least one of the goods or services in the identification of goods or services;
tallying the elections received from the at least one wireless communication device; and
sending a result of the election to the wireless communication devices, the result comprising an indication of the tally for at least one of the goods or services in the identification of goods and services.

2. The method of claim 1, further comprising:
offering an incentive for the customers to purchase the good or service that received the most elections from the wireless communication devices.

3. The method of claim 2, further comprising:
sending a predetermined time period to the wireless communication devices, the predetermined time period indicative of a time period in which the incentive is valid.

4. The method of claim 1, further comprising:
sending a status of the tally to the wireless communication devices.

5. The method of claim 4, wherein the status comprises a number of elections received from the wireless communication devices for at least some of the goods or services in the identification of goods or services.

6. The method claim 4, wherein the status comprises a new identification of goods or services comprising the identification of goods or services re-arranged in an order relating to the number of elections received for each good or service received from the wireless communication devices.

7. The method of claim 1, further comprising:
sending a predetermined time period to the wireless communication devices, the predetermined time period indicative of a time period for customers to provide the election to the computer server of at least one good or service in the identification of goods and services.

8. The method of claim 1, wherein the response is further indicative of an election of at least one good or service not in the identification of goods or services.

9. The method of claim 1, further comprising:
charging a fee to each customer who submits an election of goods or services from the identification of goods or services.

10. A wireless communication device for allowing a user of the wireless communication device to provide elections of preferred goods or services to a server, comprising:
a communication interface for wirelessly transmitting and receiving information with the server;
a user interface for receiving user input and for displaying information to the user;
a memory device for storing processor-executable instructions; and
a processor coupled to the communication interface, the user interface, and the memory for executing the processor-executable instructions that cause the wireless communication device to:
receive an identification of goods or services from the server;
display the identification of goods or services to the user;
receive an indication from the user, via the user interface, of at least one preferred good or service in the identification of goods or services;
transmit the indication to the server;
receive a result of an election of the goods or services in the identification of goods or services, the result comprising an indication of goods or services in the identification of goods or services that are most preferred by a plurality of users, each of the plurality of users operating a respective wireless communication device.

11. The wireless communication device of claim 10, wherein the processor-executable instructions further comprising instructions for the wireless communication device to:
receive an incentive for the user of the wireless communication device to purchase the good or service that received the most elections from users of the plurality of wireless communication devices and the user via the wireless communication device.

12. The wireless communication device of claim 11, wherein the processor-executable instructions further comprising instructions for the wireless communication device to:
receive a predetermined time period during which the incentive is valid.

13. The wireless communication device of claim 10, wherein the processor-executable instructions further comprising instructions for the wireless communication device to receive a status of the election from the server as the server receives indications from the plurality of users.

14. The wireless communication device of claim 13, wherein the status comprises a number of indications received from the plurality of users, each of the indications identifying at least one of the goods or services in the identification of goods or services.

15. The wireless communication device of claim 13, wherein the status comprises a new identification of goods or services comprising the identification of goods or services re-arranged in an order relating to the number of elections received for each good or service received from the wireless communication devices.

16. The wireless communication device of claim 10, wherein the processor-executable instructions further comprising instructions for the wireless communication device to:
receive a predetermined time period from the server, the predetermined time period indicative of a time period for the user of the wireless communication device to provide the indication to the server.

17. The wireless communication device of claim 10, wherein the indication comprises a selection by the user of at least one good or service not in the identification of goods or services.

18. The wireless communication device of claim 10, wherein the processor-executable instructions further comprising instructions for the wireless communication device to:
charge a fee for allowing the customer to transmit the indication to the server.

19. A server for providing an on-site election of goods or services to a plurality of customers in a venue, each of the customers operating a respective wireless communication device in communication with the server, the server comprising:
a communication interface for transmitting and receiving information with the wireless communication devices;
a memory device for storing processor-executable instructions; and
a processor coupled to the communication interface and the memory for executing the processor-executable instructions that causes the server to:
provide a sub-section of good or services normally offered to the customers via their respective wireless communication devices and a notification that the customers may elect one or more preferred goods or services in the sub-section;
receive elections from one or more of the wireless communication devices, each of the elections representing one or more preferred goods or services of the sub-section of goods or services from a respective customer;
tally the elections received from the wireless communication devices; and
send a result of the election to the wireless communication devices, the result comprising an indication of relative popularity of the goods or services in the sub-section of goods or services as determined by the number of elections received from the wireless communication devices.

20. The server of claim 19, wherein the processor-executable instructions further comprising instructions for the server to:
provide an incentive to the wireless communication devices to purchase the good or service that received the most elections within a predetermined time period.
